(19) United States
(12) Patent Application Publication
(10) Pub. No.: US 2017/0026681 A9
(43) Pub. Date: Jan. 26, 2017

(54) NOTICE-BASED DIGITAL VIDEO RECORDING SYSTEM AND METHOD

(71) Applicant: Peel Technologies, Inc., Mountain View, CA (US)

(72) Inventor: Timothy Scott, Austin, TX (US)

(21) Appl. No.: 14/179,372

(22) Filed: Feb. 12, 2014

Related U.S. Application Data
(60) Provisional application No. 61/764,235, filed on Feb. 13, 2013.

(51) Int. Cl. H04N 21/4147; H04N 21/858; H04N 21/458; H04N 21/466; H04N 21/45; H04N 21/81; H04N 21/472

(52) U.S. Cl. CPC H04N 21/4147; H04N 21/812; H04N 21/8586; H04N 21/47214; H04N 21/466; H04N 21/4532; H04N 21/4583

(57) ABSTRACT

A method and system for allowing a user to schedule a recording of a program by a digital video recorder (“DVR”) using a notice such as an advertisement, or other program notification, whether provided in print or served electronically, by engaging a user-engagable link in the notice is disclosed. The user-engagable link accesses a scheduler interface for presenting users with a process for scheduling a DVR recording. The scheduler interface is further used to determine user attributes, DVR provider information and set up account and access information and may be implemented using either a universal user interface that is common to all DVRs, customized for the user, customized for the DVR provider, or any other configuration desired.

### RELATED APPLICATIONS

This application claims benefit of priority to U.S. Provisional Patent Application No. 61/764,235 entitled “ADVERTISING-BASED DIGITAL VIDEO RECORDING SYSTEM AND METHOD”, filed Feb. 13, 2013, the aforementioned priority application being hereby incorporated by reference in its entirety.

### BACKGROUND

1. Field of Art

The disclosure generally relates to the field of digital video recording. The disclosure relates specifically to advertisement or notice-based digital video recording systems and methods.

2. Description of the Related Art

A multichannel video programming distributor (“MVPD”) is a service provider delivering video programming services, usually for a subscription fee. These operators include cable television (“CATV”) systems, direct-broadcast satellite (“DBS”) providers, and wireline video providers, such as those offered by telecommunications companies.

A “television network” is a company that produces video programs that are distributed over a broadcast channel by MVPDs among other distribution channels.

“Program” means a unit of video programming that can be scheduled for recording. This includes a single airing of a program on a certain channel (by way of example, the Super Bowl, the final 2012 presidential debate on CNN), a series (by way of example, White Collar season 5 on AMC, Seinfeld in syndication on TNT), or a particular airing of an episode of a series on a particular channel at a particular time (by way of example, Seinfeld, The Soup Nazi episode, aired Jan. 20, 2013 at 7:00 PM ET on TNT) particular airing of an episode of a series on a particular channel at a particular time on a particular MVPD service (by way of example, Seinfeld, The Soup Nazi episode, aired Jan. 20, 2013 at 6:00 PM CT on channel 245 on DIRECTV Austin, Tex.).

A digital video recorder (“DVR”) is a device that allows video programs received by a MVPD to be recorded for later on-demand viewing. Upon instruction, the DVR records programs delivered through MVPD for later viewing by a user of the DVR.

A “DVR provider” is a company that provides consumers with DVRs and the associated electronic program guide (“EPG”) service. The EPG service delivers up-to-date channel lineup and programming schedule information to the DVR over a network (satellite, cable or the Internet) and is necessary to allow users to conveniently schedule recordings on the DVR. Most often a user's DVR provider and MVPD are one and the same; however, some DVR providers do not provide MVPD services. TiVo is an example of one such DVR provider that does not provide MVPD services.

Each DVR provider will maintain an information system (“DVR provider system”) that supports certain functions such as storing and accessing information about its subscribers and remotely scheduling recordings on its subscribers' DVRs. Each DVR provider will provide access to their system over the Internet via an application programming interface (“API”) and/or via a website. A DVR provider's API and/or website enables authorized parties to perform certain functions of the system over the Internet, including scheduling a recording on a subscriber's DVR.

Scheduling a recording by a DVR can be inconvenient. While a program or series can be scheduled using the DVR itself or using the DVR provider's site (by way of example, a website or a mobile application), these options do not enables a user to spontaneously schedule a recording upon encountering a notice or advertisement of the program. For example, no convenient link exists between an advertisement (whether a print advertisement or an electronically served advertisement) and the DVR scheduling systems that enable a user to schedule the recording. The absence of a link reduces the effectiveness of the advertisement because fewer people exposed to the notice will remember it long enough to schedule the program through traditional DVR scheduling interfaces.

An example of one such link between an advertisement and using a DVR for scheduling a desired program is disclosed in U.S. Pat. No. 8,327,403 issued to Chivlers, et al., on Dec. 4, 2012. This issued US patent is directed to methods and systems for remotely scheduling for recording or ordering a program advertised on a web page of a website. A program advertisement is displayed on a user device. In response to a user's selection of the advertisement, information is transmitted from the user device to a web server of the web page without navigating the user away from the website. The information includes information that identifies a user's equipment to a remote access server, as opposed to applicant's invention which does not require the same identification of the user's equipment. A record request or an order request is transmitted by the web server to the remote access server. The remote access server cross-references the record or order request with an action request. The action request is transmitted to the user's television equipment to record or access the advertised program. This patent fails to teach taking advantage of the DVR provider system and teaches directly controlling only a DVR for recording purposes.

Furthermore, the advertisers, typically television networks, have no way to measure the effectiveness of advertisements in terms of conversions. That is, they have no way to know how many people, and which people, who encountered their ad, actually watched the program advertised.

Furthermore, if the user scheduling the program recording is requesting a program from a particular channel outside of the user's subscription, no convenient method exists for the user to add the channel to the user's subscription or otherwise acquire the program.

Furthermore, if a notice of the program is presented to the user before the program is available on the user's DVR's EPG, then it is not possible by any means to immediately schedule for the program to be recorded, further increasing the likelihood that the user will forget to record it and will not watch it.

### SUMMARY

A method and system for allowing a user to schedule a recording of a program by a digital video recorder (“DVR”) using a notice such as an advertisement, or other program notification, whether provided in print or served electronically, by engaging a user-engagable link in the notice is disclosed. The user-engagable link accesses a scheduler interface for presenting users with a process for scheduling a DVR recording. The scheduler interface is further used to determine user attributes, DVR provider information and set up account and access information and may be implemented using either a universal user interface that is common to all DVRs, customized for the user, customized for the DVR provider, or any other configuration desired.

### BRIEF DESCRIPTION OF THE DRAWINGS

The disclosed embodiments have other advantages and features that will be more readily apparent from the detailed description, the appended claims, and the accompanying figures (or drawings). A brief introduction of the figures is below.

FIG. 1 illustrates one example embodiment of Internet advertisement bearing a link for automatically scheduling a digital video recording of programs provided through a network.

FIG. 2 illustrates one example embodiment of a user interface for automatically scheduling a digital video recording of programs provided through a network.

FIG. 3 illustrates one example embodiment of a method for creating an account for automatically scheduling a digital video recording of a program with a DVR provider.

FIG. 4 illustrates one example embodiment of a method for using a link in a notice for requesting to schedule a digital video recording of a program with a DVR provider.

FIG. 5 illustrates one example embodiment of a method for fulfilling a request to schedule a digital video recording, previously requested by a user, with the user's DVR provider.

FIG. 6 illustrates one example embodiment of an advertisement for a program as it might appear in a print form (poster, billboard, magazine ad, etc.) that contains a QR code which encodes the unique URL that a user can engage in order to request recording of the program.

FIG. 7 illustrates one example embodiment of components of an example machine able to read instructions from a machine-readable medium and execute them in a processor (or controller).

FIG. 8 illustrates one example embodiment of a user interface confirming receipt of a scheduling request and for sharing the user-engagable link via various social networks.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

One embodiment described herein includes methods and system for scheduling a recording of a program by a digital video recorder (“DVR”) using a program notification, whether provided in print or served electronically, by engaging a user-engagable link in the notice. Furthermore, other embodiments described include presenting users with a process for scheduling a DVR recording that is uniform regardless of the DVR provider or the configuration of a DVR used to record the program. This process can be implemented using a universal user interface that is common to all DVRs, customized for the user, customized for the DVR provider, or other configuration that applies the methods and systems disclosed herein.

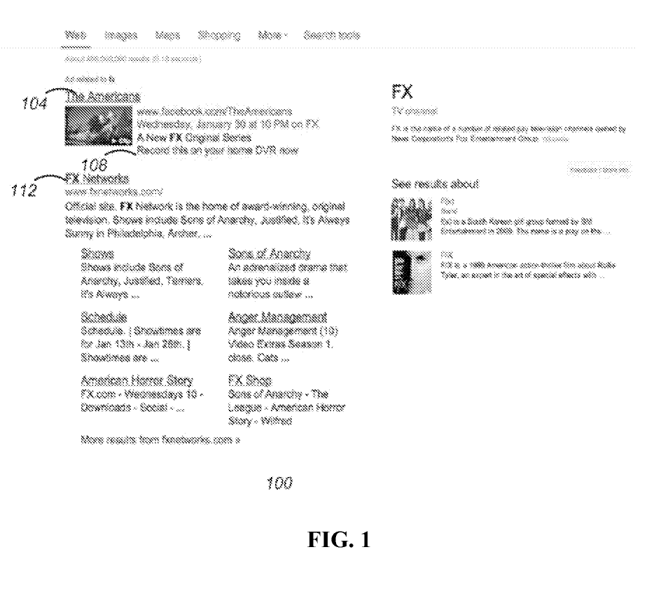

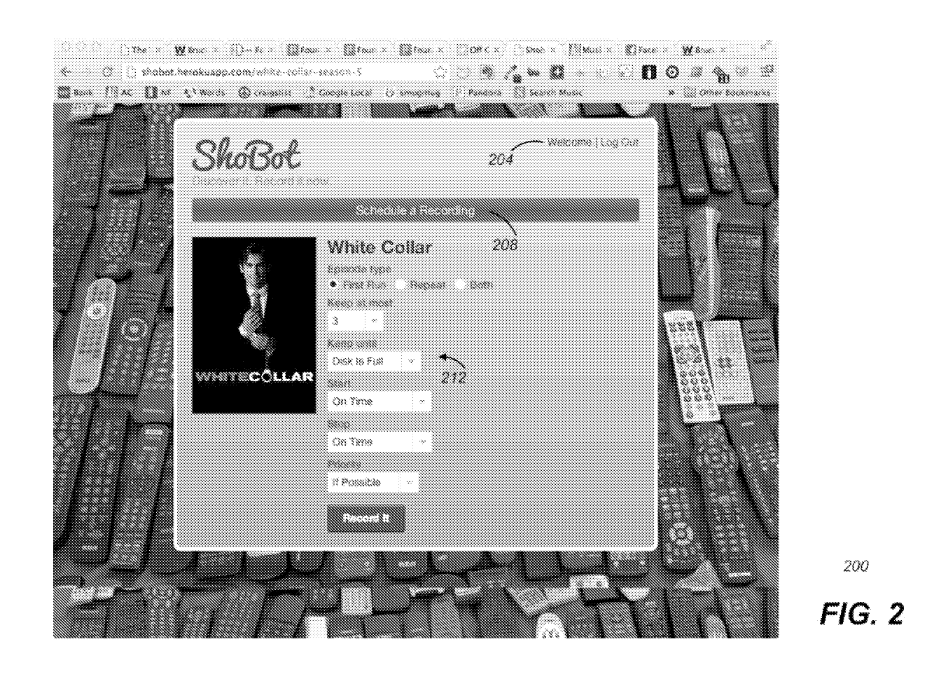

FIGS. 1 and 2 illustrate one example of using an Internet advertisement to access a scheduling interface to schedule a DVR recording. FIG. 1 illustrates an example search engine search result 100 that includes an advertisement for a television series 104 and a television network search result 112 providing the television series 104 to viewers.

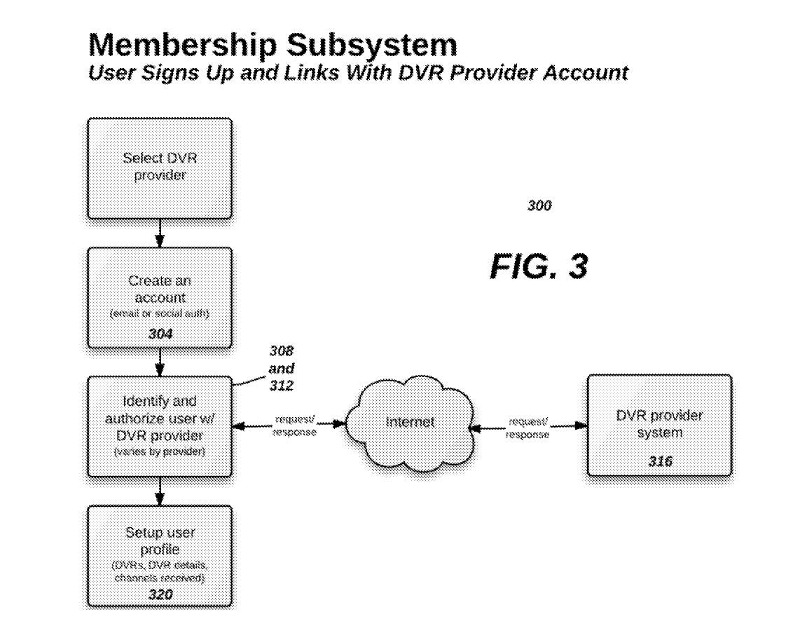

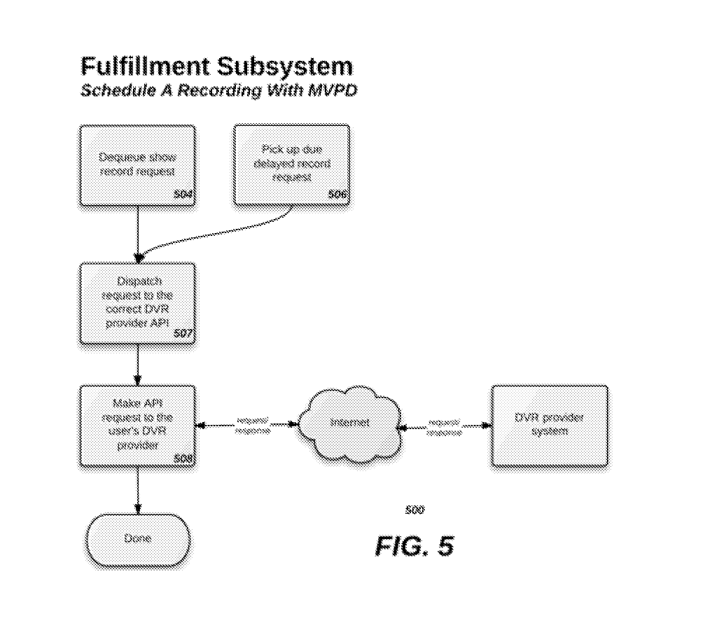

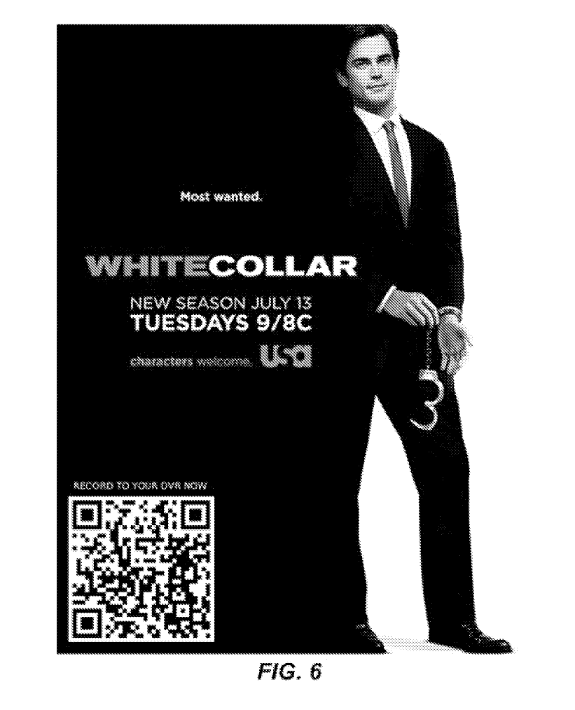

Accompanying the advertisement for the program 104 is a DVR scheduling link 108 (“Record this on your home DVR now” in FIG. 1) that enables a user of the system (further described below in the context of FIGS. 3 to 7) to conveniently schedule a recording of the program 104 upon viewing the advertisement. This is in contrast to conventional means of scheduling a DVR recording, which require a user to navigate to the particular scheduling interface provided by the DVR provider or by interacting with the DVR directly.

Upon engaging the scheduling link 108 in the advertisement 104, the user is directed to a scheduling interface 200. FIG. 2 illustrates one example scheduling interface 200 that can be provided for rendering to initiate this process. The scheduling interface 200 is used to schedule DVR recordings in a format specific to the user's DVR provider which is the standard format for that DVR provider. The scheduling interface 200 enables users to log in using the login interface 204, although when engaging the scheduling link 108 using a computing device associated with the user (by way of example, through a cookie, token, or other identifier), the user account can be automatically accessed, as is shown in this example.

The scheduling interface 200 of FIG. 2 interacts with the scheduling link 108 to uniquely identify the program to be recorded, as illustrated in a recording confirmation 208. Also in the scheduling interface 200 are various recording parameter selectors, which are customized to suit the user's DVR provider which is the standard format for that DVR provider 212. These recording parameter selectors 212 allow, for example, a user to select how long each program or each series is to be stored in the DVR memory (in order to manage the limited memory associated with the DVR), and whether to start or end the recording on time, early, or late. The recording parameter selectors 212 can also provide other recording parameters not shown that might be appropriate to the user's DVR provider's standard format. A recording instruction button 216 enables the user to finalize the instruction to record the program shown at the recording confirmation 208. The operation of the scheduling interface 200 is described in more detail in FIGS. 3 to 7.

### Establishing an Account

Turning now to FIG. 3, it illustrates an example embodiment of a method 300 in which a user creates an account at a system of the present disclosure for scheduling DVR recordings using links, advertisements, or other program notifications as illustrated in FIGS. 1 and 2. The user first creates 304 an account at the system by establishing a set of user credentials that uniquely identifies the user. In one example, the user credentials include an email address or other unique identifier provided by the user along with a security credential, such as a password. In another example, the account is created 304 using previously existing social networking account credentials. In this latter example, the user permits the system to contact social networking systems of which the user is a member (such as by way of example, FACEBOOK or GOOGLE), and provides the system with the user's social networking system credentials. The system then accesses the user's credentials at the social networking system to create a unique identifier for the user.

Alternatively, the system may merely import the user credentials associated with the user's social networking system account, thereby eliminating the need for an independent set of user credential. Other means of uniquely identifying the user at the system to establish an account include using a certificate product key, a token, or other unique identifier stored at the user's device that is provided to the system upon login.

Upon creating 304 an account and logging into the account, the user begins the account set-up process by selecting from a list of all supported DVR providers 308 the DVR provider that the user subscribes to or otherwise has access to.

After creating and accessing a user account on the system of the present disclosure, the system will negotiate a linkage with the user's account on the DVR provider system such that the system of the present disclosure will immediately receive pertinent information about the user's DVR provider account and also be granted permission to access certain features on the DVR provider system via its API or website including scheduling recordings on behalf of the user. To accomplish this linkage, the user will submit information to the DVR provider system sufficient to uniquely identify and authorize 312 accesses to the DVR provider system, in this case shown as a cable/satellite provider system 316. The information required from the user for this unique identification will vary according to the requirements of the particular DVR provider system 316. For example, one DVR provider may validate the identity of a user based solely upon an email address. Another DVR provider may validate the identity of a user by requiring an email address and an account number associated with the user at the DVR provider system 316. Yet another DVR provider may require a user to log into a user interface of the DVR provider system 316 by submitting the user credentials associated with a user account on the system. Regardless of how the DVR provider system 316 validates the user's identity, the system of the present disclosure sends the required credentials through a network, such as the Internet, to the DVR provider system 316, which then validates the user's identity.

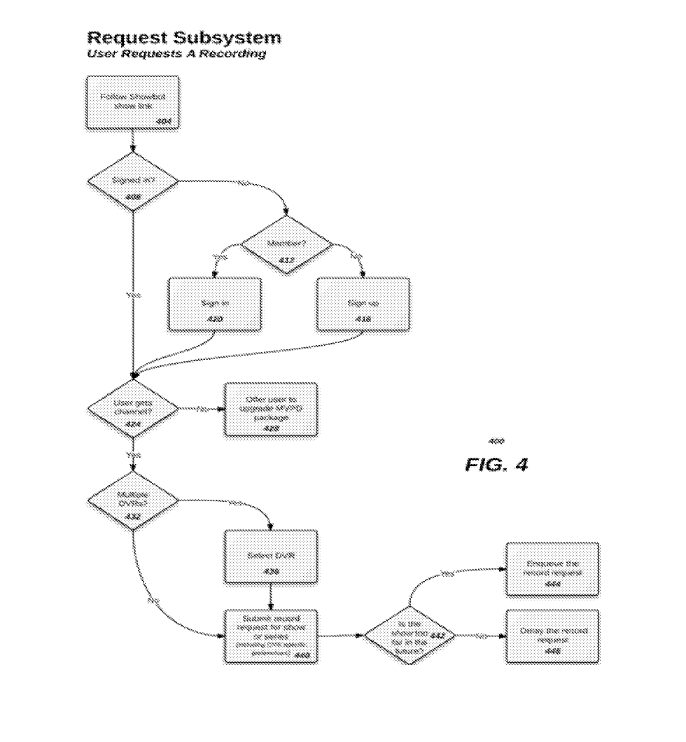

Upon validating the user's identity, the system of the present disclosure may obtain from the DVR provider system 316 details regarding the user's subscription at the DVR provider, thereby informing the system of the accessibility of programs by the user. For example, MVPDs permit users to subscribe to different sets of channels at different price points. Whether or not a user can schedule a DVR recording of a program is, in part, a function of whether the user subscribes to the channel on which the program is delivered and/or authorized to access the program itself (by way of example, in the case of pay per view programs). This subscription information can either be obtained from the DVR provider system 316 by the system of the present disclosure (and stored there), or the subscription information can be accessed by the system of the present disclosure for the identified user by communicating with the DVR provider system 316 at the time that the user makes each recording request. The details of this communication will be described in more detail in the context of FIG. 4.

The user sets up 320 a user profile in the system of the present disclosure. In the user profile, upon linking to the user's DVR provider account, the system of the present disclosure may obtain from the DVR provider system a list of all of the DVRs by which the user records programs including, for each DVR, the DVR provider system's unique identifier and the name assigned to it (by way of example, “Living Room,” “Bedroom 1,” “Sally's Room DVR”). The user profile may also include details of the user's MVPD subscription, DVR provider account information, billing and payment information, communication preferences, content preferences, and other similar information commonly found in a user profile. The purpose of storing subscription and DVR information in the system of the present disclosure is to allow the best performance when processing recording requests made by users. Alternatively, the system might not store this information but rather obtain it from the DVR provider system at the time each recording request is made, as described below with respect to FIG. 4. Whether this information is stored in the system of the present disclosure or retrieved from the DVR provider in real time might vary from one DVR provider to another.

Turning now to FIG. 4, an example method 400 is shown for scheduling a DVR recording through a uniform process, as illustrated in FIGS. 1 and 2, using a user-engagable link provided by an advertisement, or other notice of a program. A user, upon encountering an advertisement or notice of program, can engage 404 the advertisement or notice in order to be presented with the scheduling interface 200 as shown in FIG. 2.

Examples of a notice of the program bearing a user-engagable link can include, for example, a paid ad that a television network places on a website (by way of example, a search engine, a web publication of any kind), an unpaid news story in any website or web publication, an email sent by the television network or by anyone else, a social networking website, application or feed, a site that lists TV shows, an application running on a computer or mobile device that lists television shows, a television network's own site, a QR code on a billboard, a poster or flyer distributed by the television network, a QR code on a paid print ad in any kind of publication, and/or any other location at which a website link or QR code can be placed.

Regardless of the method or location used to present the user-engagable link to the user, the link includes a reference to the specific program such that the program is uniquely identified to the system when the link is engaged by the user. This unique identification can uniquely identify a one-time airing, or a series, or a specific airing of an episode of a series. This unique identification is encoded in the URL used to link the user to the system. The system maintains in its database, all necessary details about how to identify the program as needed to fulfill the recording request on each of the supported DVR provider systems.

Upon engaging 404 the user-engagable link, the system checks 408 whether the user is signed in to the system. This checking 408 includes identifying the computing device used to engage 404 the user-engagable link for a cookie or token that provides the login credential to the system without further user input or otherwise re-opens an active session of the user on the system. If the user has not yet created a user account, the user may be prompted to create 416 a user account using, for example, the method 300. If the user does have an account but is not yet signed in, the system can provide a user interface permitting the user to sign in 420 with the appropriate credentials, as shown in FIG. 2.

Once signed into the system, the system receives the specific reference to the program as encoded into the URL. From this reference, the system determines 424 the program transmission channel, and may determine whether the user is authorized to receive and record the indicated program. This determination might be based also on the user profile described above in FIG. 3, or the system may at this time make a request for this information from the DVR provider system.

In other embodiments, the system may determine whether the user subscribes to the requested program as part of its current DVR provider subscription by referencing the user account created in example method 300 or by immediately requesting this information from the DVR provider system. If it is determined that the user subscribes to the program, the recording request can proceed. If the user does not subscribe the program, the system can then present to the user an offer to upgrade 428 the content subscription or otherwise acquire the program, thereby enabling the user to access the requested program.

Once the system checks 424 whether the user subscribes to the program, the system identifies 432 whether the user uses multiple DVRs by referencing the user account created in example method 300 or by immediately requesting this information from the DVR provider system. If so, the user selects 436 which DVR to use in recording the program. The request to record the program is saved in the database and placed on a queue 444 to be fulfilled by the system at a later time, which could be mere minutes or seconds later. The important point is that the recording is not scheduled with DVR provider while the user waits but rather is handed off to a different subsystem.

In some situations, a notice of a program is presented to users before the user's DVR's EPG is updated to include the program that is requested to be recorded. Upon a user engaging a link, the system may reference the user account created in example method 300 or the system may immediately request this information from the DVR provider system to determine 442 whether the requested program is too far in the future to be recorded and if so, delay the record request 446 to wait until a time that the recording can be scheduled or, if the program is schedulable, then queues the recording request 444 according to the methods described above.

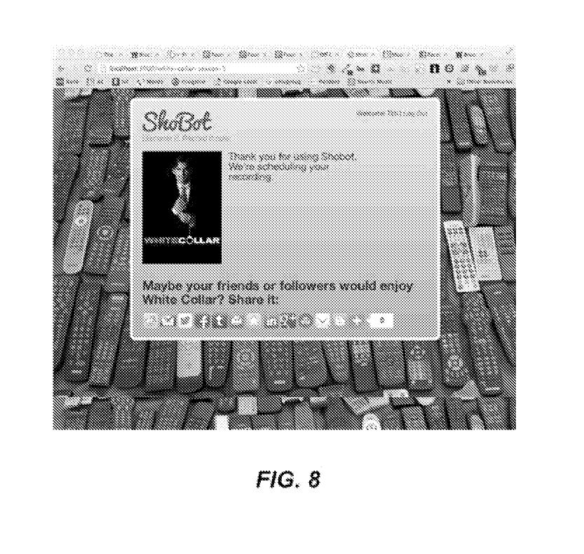

In some cases the recording request will conflict with previously scheduled recordings on the user's DVR. It depends on the individual capabilities of the DVR to record multiple shows simultaneously and whether other programs are previously scheduled at the time or times requested. The method for resolving conflicts might vary from one DVR provider to another. Wherever possible, the system's recording request will include a choice by the user of how to handle any such conflicts that may occur. The user will specify whether they want the current request to take priority or not. If they opt for the former, a previously scheduled recording will be cancelled to allow for the current request to be fulfilled. If the DVR provider does not support this kind of prioritized conflict resolution, the system will cancel the request and may notify the user that their request could not be fulfilled. FIG. 8 illustrates one example embodiment of a user interface confirming receipt of a scheduling request and for sharing the user-engagable link via various social networks

### Computing Machine Architecture

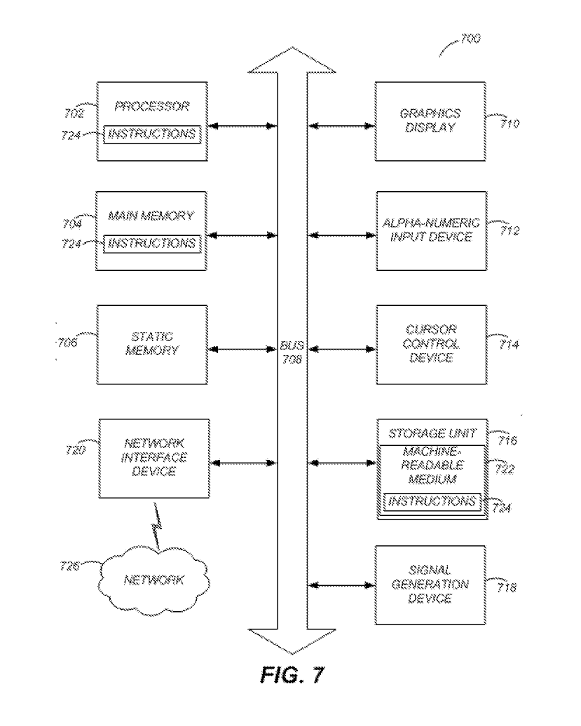

FIG. 7 is a block diagram illustrating components of an example machine able to read instructions from a machine-readable medium and execute them in a processor (or controller). The instructions would correspond to the processes described with respect to FIGS. 1 through 6. In particular, FIG. 7 shows a diagrammatic representation of a machine in the example form of a computer system 700 within which instructions 724 (by way of example, software) for causing the machine to perform any one or more of the methodologies discussed herein may be executed. In alternative embodiments, the machine operates as a standalone device or may be connected (by way of example, networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 724 (sequential or otherwise) that specify actions to be taken by that machine. Further, while only a single machine is illustrated, the term “machine” shall also be taken to include any collection of machines that individually or jointly execute instructions 724 to perform any one or more of the methodologies discussed herein.

The example computer system 700 includes a processor 702 (by way of example, a central processing unit (CPU), a graphics processing unit (GPU), a digital signal processor (DSP), one or more application specific integrated circuits (ASICs), one or more radio-frequency integrated circuits (RFICs), or any combination of these), a main memory 704, and a static memory 706, which are configured to communicate with each other via a bus 708. The computer system 700 may further include graphics display unit 710 (by way of example, a plasma display panel (PDP), a liquid crystal display (LCD), a projector, or a cathode ray tube (CRT)). The computer system 700 may also include alphanumeric input device 712 (by way of example, a keyboard), a cursor control device 714 (by way of example, a mouse, a trackball, a joystick, a motion sensor, or other pointing instrument), a storage unit 716, a signal generation device 718 (by way of example, a speaker), which also are configured to communicate via the bus 708.

The storage unit 716 includes a machine-readable medium 722 on which is stored instructions 724 (by way of example, software) embodying any one or more of the methodologies or functions described herein. The instructions 724 (by way of example, software) may also reside, completely or at least partially, within the main memory 704 or within the processor 702 (by way of example, within a processor's cache memory) during execution thereof by the computer system 700, the main memory 704 and the processor 702 also constituting machine-readable media. The instructions 724 (by way of example, software) may be transmitted or received over a network 726 via the network interface device 720.

While machine-readable medium 722 is shown in an example embodiment to be a single medium, the term “machine-readable medium” should be taken to include a single medium or multiple media (by way of example, a centralized or distributed database, or associated caches and servers) able to store instructions (by way of example, instructions 724). The term “machine-readable medium” shall also be taken to include any medium that is capable of storing instructions (by way of example, instructions 724) for execution by the machine and that cause the machine to perform any one or more of the methodologies disclosed herein. The term “machine-readable medium” includes, but not be limited to, data repositories in the form of solid-state memories, optical media, and magnetic media.

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments, by way of example, FIGS. 3-6, are described herein as including logic or process steps. They may correspond to functional components, modules, or mechanisms. Modules may constitute either software modules (by way of example, code embodied on a machine-readable medium or in a transmission signal) or hardware modules. A hardware module is tangible unit capable of performing certain operations and may be configured or arranged in a certain manner. In example embodiments, one or more computer systems (by way of example, a standalone, client or server computer system) or one or more hardware modules of a computer system (by way of example, a processor or a group of processors) may be configured by software (by way of example, an application or application portion) as a hardware module that operates to perform certain operations as described herein.

In various embodiments, a hardware module may be implemented mechanically or electronically. For example, a hardware module may comprise dedicated circuitry or logic that is permanently configured (by way of example, as a special-purpose processor, such as a field programmable gate array (FPGA) or an application-specific integrated circuit (ASIC)) to perform certain operations. A hardware module may also comprise programmable logic or circuitry (by way of example, as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (by way of example, configured by software) may be driven by cost and time considerations.

The various operations of example methods described herein may be performed, at least partially, by one or more processors that are temporarily configured (by way of example, by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (by way of example, the Internet) and via one or more appropriate interfaces (by way of example, application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (by way of example, within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (by way of example, a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (by way of example, a computer) that manipulates or transforms data represented as physical (by way of example, electronic, magnetic, or optical) quantities within one or more memories (by way of example, volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

What is claimed is:

1. A notice-based digital video recording method comprising the steps of:
embedding a user-engagable link in a web page provided from a web server to a user device wherein said user-engagable link corresponds to an advertisement or other notice of a television program or series;
creating a user account for use by a system having a scheduler interface; utilizing said scheduler interface for presenting users with a process for scheduling a DVR recording of said television program or series wherein said scheduler interface is further used to determine user attributes, DVR provider system information and set up account and access information; and displaying said scheduler interface as a universal user interface that is common to all DVRs, customized for the user, customized for the DVR provider for allowing the user to schedule said DVR recording of said television program or series.

2. The method of claim 1, further comprising the step of:
providing said scheduler interface with a user account and one or more recording parameter selectors, which are customized to suit the user's DVR provider system wherein said recording parameter selectors allow the user to select various aspects of how the recording should be performed.

3. The method of claim 2, further comprising the step of:
creating said user account for use by said scheduler interface by establishing a set of user credentials that uniquely identifies the user wherein the user credentials include an email address or other unique identifier provided by the user along with a security credential, such as a password, product key or token.

4. The method of claim 2, further comprising the step of:
creating said user account using previously existing social networking account credentials wherein the user permits use of their social networking system of which the user is a member and allows a user's social networking system credentials to create said user account with a unique identifier for the user.

5. The method of claim 1, further comprising the step of:
selecting from a list of all supported DVR providers the DVR provider that the user subscribes to or otherwise has access to wherein the user submits information to the DVR provider system sufficient to uniquely identify and authorize access to the DVR provider system.

6. The method of claim 6, further comprising the step of:
retrieving from the DVR provider system the user's subscription at the DVR provider, thereby linking said scheduler interface the accessibility of programs permitted for the user for informing the user which television programs may be scheduled and how the user may schedule programs or series.

7. The method of claim 1, further comprising the step of:
presenting said user-engagable link for identifying a television program may be in a paid ad that a television network places on a website, an unpaid news story in any website or web publication, an email sent by a television network, a social networking website, a site that lists television shows, an application running on a computer or mobile device that lists television shows, a television network's own site, a QR code on a billboard, a poster or flyer distributed by the television network, a QR code on a paid print ad in any kind of publication, and/or any other location at which a website link or QR code may be placed.

8. The method of claim 1, further comprising the step of:
identifying a specific television program using said user-engagable link as a reference to the specific program such that the program is identified to the system when the link is engaged by the user wherein said identification can identify a one-time airing, or a series, or a specific airing of an episode of a series wherein said identification is encoded in a URL used to link the user to said system wherein said system maintains in its database all necessary details about how to identify the program as needed to fulfill the recording request on each of said DVR provider systems.

9. The method of claim 1, further comprising the step of:
identifying whether the user uses multiple DVRs by immediately requesting this information from said DVR provider system so as to allow the user to select which DVR to use in recording a program and said request to record the program is saved in a database and placed on a queue to be fulfilled by said system immediately or at a later time.

10. The method of claim 9, further comprising the step of:
determining whether said requested program is too far in the future to be recorded and if so, delay fulfillment of the record request until a time that said recording can be scheduled.

11. The method of claim 1, further comprising the step of:
providing a parameter selector that allows a choice by the user of how to handle scheduling conflicts that may occur wherein the user will specify whether they want the current request to take priority or not.

12. A notice-based digital video recording system comprising:
a user-engagable link embedded in a web page from a web server to a user device wherein said user-engagable link corresponds to a notice of a television program or series; a user account created by computer software having a scheduler interface; wherein said scheduler interface presents users with a process for scheduling a DVR recording of said television program or series wherein said scheduler interface is further used to determine user attributes, DVR provider system information and set up account and access information; and said scheduler interface is a universal user interface that is common to all DVRs, customized for the user, customized for the DVR provider for allowing the user to schedule said DVR recording of said television program or series.

13. The system of claim 12, further comprising:
said scheduler interface associated with a user account and one or more recording parameter selectors, which are customized to suit the user's DVR provider system wherein said recording parameter selectors allow the user to select various aspects of how the recording should be performed.

14. The system of claim 13, further comprising:
said user account establishes a set of user credentials that uniquely identifies the user wherein the user credentials include an email address or other unique identifier provided by the user along with a security credential, such as a password, product key or token.

15. The system of claim 13, further comprising:
said user account associated with existing social networking account credentials wherein the user permits use of their social networking system of which the user is a member and allows a user's social networking system credentials to create said user account with a unique identifier for the user.

16. The system of claim 12, further comprising:
the user submits information to said DVR provider system sufficient to uniquely identify and authorize access to said DVR provider system selected from a list of all supported DVR providers the DVR provider that the user subscribes to or otherwise has access too.

17. The system of claim 16, further comprising:
said scheduler interface informing the user which television programs may be scheduled and how the user may schedule programs or series.

18. The system of claim 12, further comprising:
said user-engagable link identifies a television program which may be in a paid ad that a television network places on a website, an unpaid news story in any website or web publication, an email sent by a television network, a social networking website, a site that lists television shows, an application running on a computer or mobile device that lists television shows, a television network's own site, a QR code on a billboard, a poster or flyer distributed by the television network, a QR code on a paid print ad in any kind of publication, and/or any other location at which a website link or QR code may be placed.

19. The system of claim 12, further comprising:
said user-engagable link references a specific program such that the program is identified to the system when the link is engaged by the user wherein said identification can identify a one-time airing, or a series, or a specific airing of an episode of a series wherein said identification is encoded in a URL used to link the user to said system wherein said system maintains in its database all necessary details about how to identify the program as needed to fulfill the recording request on each of said DVR provider systems.

20. The system of claim 12, further comprising:
the user selects which DVR to use in recording a program and said request to record the program is saved in a database and placed on a queue to be fulfilled by said system immediately or at a later time.
